(19) United States
(12) Patent Application Publication
(10) Pub. No.: US 2025/0317865 A1
(43) Pub. Date: Oct. 9, 2025

(54) PHYSICAL UPLINK SHARED CHANNEL POWER CONTROL FOR RANDOM ACCESS IN SUBBAND FULL-DUPLEX NETWORKS

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Abdelrahman Mohamed IBRAHIM, San Diego, CA (US); Wanshi CHEN, San Diego, CA (US)

(21) Appl. No.: 19/092,937

(22) Filed: Mar. 27, 2025

Related U.S. Application Data
(60) Provisional application No. 63/574,135, filed on Apr. 3, 2024.

(51) Int. Cl. H04W 52/08; H04L 5/16; H04W 52/14; H04W 52/50

(52) U.S. Cl. CPC H04W 52/08; H04L 5/16; H04W 52/146; H04W 52/50

(57) ABSTRACT

Methods, systems, and devices for wireless communications are described. The described techniques may enable a wireless device to calculate a closed loop power control parameter for a physical uplink shared channel (PUSCH) message in a random access channel (RACH) procedure in cases where one or more RACH preambles are transmitted in slots with a different slot type (e.g., half-duplex (HD) or subband full-duplex (SBFD)) than a slot used to transmit the PUSCH message. For example, the wireless device may determine a power ramping parameter based on a total quantity of preambles transmitted. Additionally, or alternatively, the wireless device may determine a power ramping parameter based on a quantity of preambles transmitted via slots of the first slot type (e.g., and not preambles transmitted via slots of the different slot type). Additionally, or alternatively, the wireless device may apply a power ramping adjustment parameter.

### CROSS REFERENCES

The present Application for Patent claims benefit of U.S. Provisional Patent Application No. 63/574,135 by ABOTABL et al., entitled “PHYSICAL UPLINK SHARED CHANNEL POWER CONTROL FOR RANDOM ACCESS IN SUBBAND FULL-DUPLEX NETWORKS,” filed Apr. 3, 2024, assigned to the assignee hereof, and expressly incorporated herein.

### FIELD OF TECHNOLOGY

The following relates to wireless communications, including physical uplink shared channel (PUSCH) power control for random access in subband full-duplex (SBFD) networks.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support physical uplink shared channel (PUSCH) power control for random access in subband full-duplex (SBFD) networks. For example, the described techniques may enable a wireless device to calculate a closed loop power control parameter for a PUSCH message in a random access channel (RACH) procedure in cases where one or more RACH preambles are transmitted in slots with a different slot type (e.g., half-duplex (HD) or SBFD) than a first slot type of a slot used to transmit the PUSCH message. For example, the wireless device may determine a power ramping parameter based on a total quantity of preambles transmitted (e.g., and a power ramping step parameter associated with the first slot type). Additionally, or alternatively, the wireless device may determine a power ramping parameter based on a quantity of preambles transmitted via slots of the first slot type (e.g., and not preambles transmitted via slots of the different slot type). Additionally, or alternatively, the wireless device may apply a power ramping adjustment parameter (e.g., an overall power adjustment parameter or a power adjustment parameter corresponding to a quantity of preambles transmitted via slots with a slot type different than the first slot type).

A method for wireless communications by a wireless device is described. The method may include transmitting one or more preambles of a RACH procedure via a corresponding one or more slots, transmitting a PUSCH message of the RACH procedure in an additional slot using a transmit power based on a quantity of preambles of the one or more preambles and on a slot type of the additional slot, the slot type including a HD slot or a SBFD slot, and monitoring for a message responsive to the one or more preambles, the PUSCH message, or both.

A wireless device for wireless communications is described. The wireless device may include one or more memories storing processor executable code, and one or more processors coupled with the one or more memories. The one or more processors may individually or collectively be operable to execute the code to cause the wireless device to transmit one or more preambles of a RACH procedure via a corresponding one or more slots, transmit a PUSCH message of the RACH procedure in an additional slot using a transmit power based on a quantity of preambles of the one or more preambles and on a slot type of the additional slot, the slot type including a HD slot or a SBFD slot, and monitor for a message responsive to the one or more preambles, the PUSCH message, or both.

Another wireless device for wireless communications is described. The wireless device may include means for transmitting one or more preambles of a RACH procedure via a corresponding one or more slots, means for transmitting a PUSCH message of the RACH procedure in an additional slot using a transmit power based on a quantity of preambles of the one or more preambles and on a slot type of the additional slot, the slot type including a HD slot or a SBFD slot, and means for monitoring for a message responsive to the one or more preambles, the PUSCH message, or both.

A non-transitory computer-readable medium storing code for wireless communications is described. The code may include instructions executable by one or more processors to transmit one or more preambles of a RACH procedure via a corresponding one or more slots, transmit a PUSCH message of the RACH procedure in an additional slot using a transmit power based on a quantity of preambles of the one or more preambles and on a slot type of the additional slot, the slot type including a HD slot or a SBFD slot, and monitor for a message responsive to the one or more preambles, the PUSCH message, or both.

In some examples of the method, wireless devices, and non-transitory computer-readable medium described herein, the transmit power associated with transmission of the PUSCH message may be based on a closed loop power control parameter, a value of the closed loop power control parameter may be based on a multiplication of a power ramping increment parameter associated with the slot type of the additional slot by the quantity of preambles of the one or more preambles, and the quantity of preambles corresponds to a total quantity of preambles transmitted by the wireless device for the RACH procedure.

In some examples of the method, wireless devices, and non-transitory computer-readable medium described herein, the transmit power associated with transmission of the PUSCH message may be based on a closed loop power control parameter, a value of the closed loop power control parameter may be based on a multiplication of a power ramping increment parameter associated with the slot type of the additional slot by the quantity of preambles of the one or more preambles, and the quantity of preambles corresponds to a quantity of preambles transmitted by the wireless device for the RACH procedure via a subset of slots of the one or more slots that may be associated with a same slot type as the slot type of the additional slot.

In some examples of the method, wireless devices, and non-transitory computer-readable medium described herein, the transmit power associated with transmission of the PUSCH message may be based on a closed loop power control parameter, a value of the closed loop power control parameter may be based on a multiplication of a power ramping increment parameter associated with the slot type of the additional slot by a first quantity of a first subset of the quantity of preambles and a multiplication of a power ramping increment parameter associated with a slot type different from the slot type of the additional slot by a second quantity of a second subset of the quantity of preambles, the first subset of the quantity of preambles corresponds to a quantity of preambles transmitted by the wireless device for the RACH procedure via a first set of slots of the one or more slots that may be associated with a same slot type as the slot type of the additional slot, and the second subset of the quantity of preambles corresponds to a quantity of preambles transmitted by the wireless device for the RACH procedure via a second set of slots of the one or more slots that may be associated with the slot type that may be different than the slot type of the additional slot.

In some examples of the method, wireless devices, and non-transitory computer-readable medium described herein, a closed loop power control parameter may be based on a closed loop power adjustment parameter associated with the slot type of the additional slot and the transmit power may be based on the closed loop power control parameter.

In some examples of the method, wireless devices, and non-transitory computer-readable medium described herein, the closed loop power adjustment parameter may be multiplied by the quantity of preambles of the one or more preambles and the quantity of preambles corresponds to a quantity of preambles transmitted by the wireless device for the RACH procedure via a subset of slots of the one or more slots that may be associated with a slot type that may be different from the slot type of the additional slot.

In some examples of the method, wireless devices, and non-transitory computer-readable medium described herein, the transmit power associated with transmission of the PUSCH message may be based on a closed loop power control parameter and a value of the closed loop power control parameter may be based on a power ramping parameter that may be set to zero upon transmission of a first preamble of the one or more preambles in a first slot of the one or more slots associated with a first slot type and transmission of a subsequent preamble of the one or more preambles in a second slot of the one or more slots associated with a second slot type different from the first slot type.

In some examples of the method, wireless devices, and non-transitory computer-readable medium described herein, the transmit power associated with transmission of the PUSCH message may be based on a closed loop power control parameter, a value of the closed loop power control parameter may be based on a multiplication of a power ramping increment parameter associated with the second slot type by the quantity of preambles of the one or more preambles, and the quantity of preambles corresponds to a quantity of preambles transmitted by the wireless device for the RACH procedure via a subset of slots of the one or more slots associated with the second slot type after the power ramping parameter may be set to zero.

In some examples of the method, wireless devices, and non-transitory computer-readable medium described herein, the transmit power may be based on a closed loop power control state associated with the slot type of the additional slot.

Some examples of the method, wireless devices, and non-transitory computer-readable medium described herein may further include operations, features, means, or instructions for receiving the message responsive to the one or more preambles, the PUSCH message, or both, where the message includes an indication of the closed loop power control state.

In some examples of the method, wireless devices, and non-transitory computer-readable medium described herein, the closed loop power control state may be based on the slot type of the additional slot.

In some examples of the method, wireless devices, and non-transitory computer-readable medium described herein, transmitting the one or more preambles may include operations, features, means, or instructions for transmitting the one or more preambles via a corresponding one or more physical RACH (PRACH) resources of the one or more slots.

### BRIEF DESCRIPTION OF THE DRAWINGS

FIG. 1 shows an example of a wireless communications system that supports physical uplink shared channel (PUSCH) power control for random access in subband full-duplex (SBFD) networks in accordance with one or more aspects of the present disclosure.

FIG. 2 shows an example of a wireless communications system that supports PUSCH power control for random access in SBFD networks in accordance with one or more aspects of the present disclosure.

FIG. 3 shows examples of power ramping diagrams that support PUSCH power control for random access in SBFD networks in accordance with one or more aspects of the present disclosure.

FIG. 4 shows an example of a process flow that supports PUSCH power control for random access in SBFD networks in accordance with one or more aspects of the present disclosure.

FIGS. 5 and 6 show block diagrams of devices that support PUSCH power control for random access in SBFD networks in accordance with one or more aspects of the present disclosure.

FIG. 7 shows a block diagram of a communications manager that supports PUSCH power control for random access in SBFD networks in accordance with one or more aspects of the present disclosure.

FIG. 8 shows a diagram of a system including a device that supports PUSCH power control for random access in SBFD networks in accordance with one or more aspects of the present disclosure.

FIGS. 9 through 11 show flowcharts illustrating methods that support PUSCH power control for random access in SBFD networks in accordance with one or more aspects of the present disclosure.

### DETAILED DESCRIPTION

In some wireless communication systems, a wireless device (e.g., a user equipment (UE), a network entity, an integrated access and backhaul (IAB) node) may perform a random access channel (RACH) procedure by transmitting one or more RACH preambles and a physical uplink shared channel (PUSCH) message. In some examples, the wireless device may determine a transmit power of the PUSCH message based on a quantity of RACH preambles previously transmitted by the wireless device. For example, an equation used to calculate the transmit power may include a closed loop power control term, which may be based on a power ramping parameter associated with the quantity of RACH preambles.

In some examples, the wireless device may use subband full-duplex (SBFD) or half-duplex (HD) techniques to perform a RACH procedure. For example, the wireless device may transmit the RACH preambles and the PUSCH message in HD slots (e.g., slots including uplink subbands) or SBFD slots (e.g., slots including both uplink and downlink subbands). In such examples, however, the wireless device may use a different power ramping parameter in SBFD slots than in HD slots. Accordingly, the wireless device may not be aware of how to calculate the closed loop power control term if one or more preambles are transmitted in slots with a different slot type (e.g., HD or SBFD) than a slot used to transmit the PUSCH message.

Techniques described herein may enable the wireless device to calculate the closed loop power control parameter for a PUSCH message in cases where one or more RACH preambles are transmitted in slots with a different slot type (e.g., HD or SBFD) than a first slot type of a slot used to transmit the PUSCH message. For example, the wireless device may determine a closed loop power control parameter based on a quantity of preambles transmitted and the first slot type of the slot used to transmit the PUSCH message. Such techniques may allow the wireless device to perform power control for PUSCH messages in SBFD networks, which may decrease latency and improve utilization of resources in the network by enabling the wireless device to perform RACH via both HD and SBFD slots.

In some examples, to determine the closed loop power control parameter, the wireless device may determine a power ramping parameter based on a total quantity of preambles transmitted (e.g., and a power ramping step parameter associated with the first slot type). Additionally, or alternatively, the wireless device may determine a power ramping parameter based on a quantity of preambles transmitted via slots of the first slot type (e.g., and not preambles transmitted via slots of the different slot type). Additionally, or alternatively, the wireless device may apply a power ramping adjustment parameter (e.g., an overall power adjustment parameter or a power adjustment parameter corresponding to a quantity of preambles transmitted via slots with a slot type different than the first slot type) to the closed loop power control parameter. Such techniques may allow the wireless device to enable the wireless device to use a combination of HD and SBFD slots for a RACH procedure, which may further decrease latency and improve utilization of resources.

In some examples (e.g., if the wireless device resets a power ramping parameter upon switching slot types used to transmit preambles), the wireless device may calculate the closed loop power control parameter based on a total quantity of preambles transmitted, a quantity of preambles transmitted via the first slot type, or a total quantity of preambles transmitted after a latest power ramping parameter reset. In some examples, the wireless device may identify multiple closed loop power control states (e.g., a closed loop power control state corresponding for PUSCH transmitted via an HD slot and a closed loop power control state corresponding for PUSCH transmitted via an SBFD slot). The wireless device may calculate the closed loop power control parameter based on the closed loop power control state (e.g., in addition to or instead of a power control adjustment parameter), which may decrease processing at the wireless device.

Aspects of the disclosure are initially described in the context of wireless communications systems. Aspects of the disclosure are further illustrated by and described with reference to power ramping diagrams, process flows, apparatus diagrams, system diagrams, and flowcharts that relate to PUSCH power control for random access in SBFD networks.

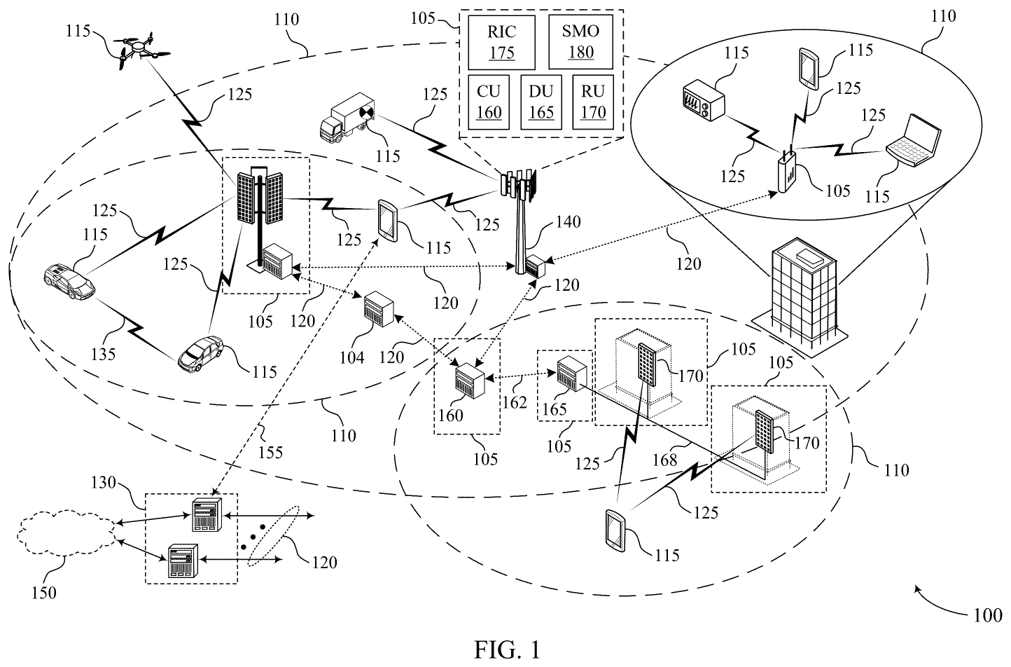

FIG. 1 shows an example of a wireless communications system 100 that supports PUSCH power control for random access in SBFD networks in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Nf may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., Nf) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as HD communications (e.g., a mode that supports one-way communication via transmission or reception, but not transmission and reception concurrently). In some examples, HD communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard- band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples, the wireless communications system 100 may support HD communications (e.g., frequency division duplexing (FDD) or time division duplexing (TDD), in which a UE 115 or a network entity 105 may perform communication of downlink signaling and communication of uplink signaling via resources that do not overlap in time or frequency, respectively. For example, for FDD operations, the network entity 105 may allocate a dedicated downlink transmission frequency bandwidth, a dedicated uplink transmission frequency bandwidth, and a dedicated supplementary uplink frequency bandwidth (e.g., defined by a central frequency and a frequency range or quantity of resource blocks (RBs)), and may schedule the downlink and uplink communications in overlapping time resources. For TDD operations, the network entity 105 may allocate a dedicated downlink and uplink transmission frequency bandwidth and a dedicated supplementary uplink frequency bandwidth (e.g., defined by a central frequency and a frequency range or quantity of RBs), and may schedule the downlink and uplink communications in non-overlapping time resources.

In some examples, the wireless communications system 100 may support full-duplex communications, in which a UE 115 or a network entity 105 may perform simultaneous communication of downlink signaling and communication of uplink signaling on a frequency subband basis (e.g., across a set of frequencies). For example, for SBFD communications (e.g., subband non-overlapping full duplex), the network entity 105 may partition a particular frequency band (e.g., 100 MHz) into subbands which the network entity 105 may use exclusively for uplink or downlink communications. For example, the network entity 105 may use the 40 MHz of a 100 MHz band for downlink communications, 20 MHz for uplink communications, and another 40 MHz again for downlink communications. That is, the uplink and downlink subbands may have relatively similar frequencies, however, may be non-overlapping in frequency. Full-duplex communications may be suitable for macro cells with a large transmit power, and may be relatively simpler to enable than other full-duplex techniques. In some examples, such SBFD communication techniques may also support a dedicated frequency band for supplementary uplink communications, as described with reference to FDD and TDD communications.

To further enhance flexibility of some operations, the wireless communications system 100 may support UEs 115 and network entities 105 which may both perform simultaneous transmission and reception of downlink and uplink communications via partially or fully overlapping frequency bands. For example, the wireless communications system 100 may support a network entity 105 that operates using full-duplex communications via partially overlapping frequency bands, or a network entity 105 that operates using HD communications (e.g., in a multi-transmission reception point (mTRP)) scenario) and a UE 115 that operates using full-duplex communications.

In some scenarios, network entities 105 in the wireless communications system 100 may support full-duplex operations (e.g., where a network entity 105 may communicate simultaneously on uplink and downlink sub-bands that are non-overlapping in frequency), while UEs 115 may support HD communications. For example, the network entity 105 may use a particular sub-band for transmitting downlink communications to a first UE 115, and a particular sub-band for receiving simultaneous uplink communications from a second UE 115. As such, a UE 115 capable of HD communications may be paired with any network entity 105 capable of full-duplex operations in the wireless communications system 100.

In some examples, the network entity 105 may use IBFD communications, in which the network entity 105 may transmit and receive communications with a UE 115 via a same time resource and a same frequency resource. That is, the downlink and uplink may share same IBFD time and frequency resources, which may partially or fully overlap. Alternatively, the network entity 105 may use SBFD (e.g., flexible duplex) communications, in which the network entity 105 may transmit and receive communications with the UE 115 via a same time resource but via different frequency resources. That is, a frequency resource used for downlink communications may be separated from a frequency resource used for uplink communications (e.g., by a guard band). In some examples, the network entity 105 may use SBHD, in which the network entity 105 may transmit and receive communications with the UE 115 via frequency subbands that do not overlap in time or frequency. Such techniques may allow for the network entity 105 to transition between a HD mode (e.g., TDD or FDD) and a full-duplex mode (e.g., SBFD, IBFD).

In some examples of the wireless communications system 100 supporting full-duplex (e.g., SBFD) communications, a wireless device (e.g., a UE 115, a network entity 105, an IAB node) may perform a RACH procedure by transmitting one or more RACH preambles via RACH occasions in either or both of SBFD or HD slots. In some examples, the wireless device may receive a semi-static indication (e.g., via a system information block (SIB)) of SBFD configurations indicating time and frequency locations of SBFD subbands (e.g., while the wireless device is in an RRC_CONNECTED, RRC_IDLE, or RRC_INACTIVE mode). If the wireless device supports random access in SBFD symbols, the wireless device may transmit the RACH preambles in SBFD slots according to the SBFD configuration.

In some examples, the wireless device may transmit the one or more RACH preambles and monitor for a response (e.g., an RAR) to each preamble (e.g., from another wireless device, such as a network entity 105). If the wireless device does not receive a response to the preambles, the wireless device may determine that the other wireless device did not receive the preambles. The wireless device may accordingly increase a transmit power used to transmit the preambles. Such techniques may be referred to as power ramping. The wireless device may use a power ramping accumulated while transmitting the preambles to determine a transmit power for a PUSCH message.

Techniques described herein may enable a wireless device (e.g., a UE 115, a network entity 105, an IAB node) to calculate a closed loop power control parameter for a PUSCH message in cases where one or more RACH preambles are transmitted via slots with a different slot type (e.g., HD or SBFD) than a first slot type of a slot used to transmit the PUSCH message. For example, the wireless device may determine a power ramping parameter based on a total quantity of preambles transmitted (e.g., and a power ramping step parameter associated with the first slot type). Additionally, or alternatively, the wireless device may determine a power ramping parameter based on a quantity of preambles transmitted via slots of the first slot type (e.g., and not preambles transmitted via slots of the different slot type). Additionally, or alternatively, the wireless device may apply a power ramping adjustment parameter (e.g., an overall power adjustment parameter or a power adjustment parameter corresponding to a quantity of preambles transmitted via slots with a slot type different than the first slot type).

In some examples (e.g., if the wireless device resets a power ramping parameter upon switching slot types used to transmit preambles), the wireless device may calculate the closed loop power control parameter based on a total quantity of preambles transmitted, a quantity of preambles transmitted via the first slot type, or a total quantity of preambles transmitted after a latest power ramping parameter reset. In some examples, the wireless device may identify multiple closed loop power control states (e.g., a closed loop power control state corresponding for PUSCH transmitted via an HD slot and a closed loop power control state corresponding for PUSCH transmitted via an SBFD slot). The wireless device may calculate the closed loop power control parameter based on the closed loop power control state.

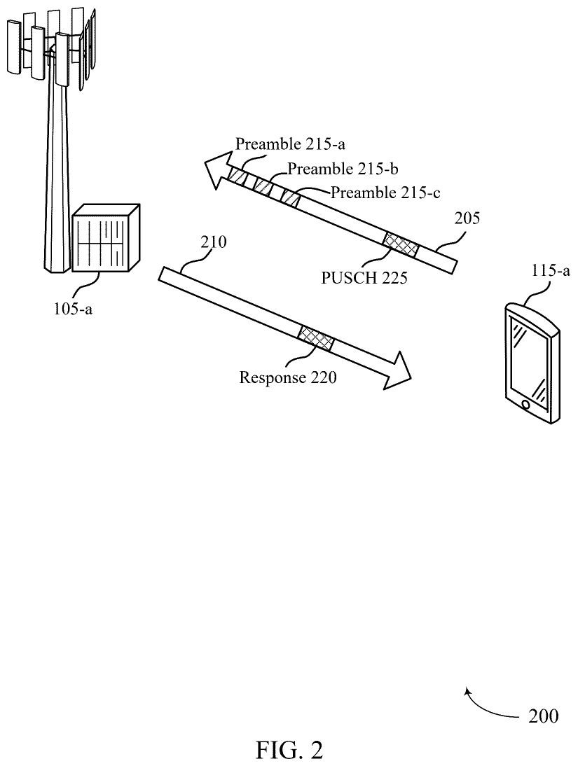

FIG. 2 shows an example of a wireless communications system 200 that supports PUSCH power control for random access in SBFD networks in accordance with one or more aspects of the present disclosure. The wireless communications system 200 may implement or may be implemented by aspects of the wireless communications system 100. For example, the wireless communications system 200 may include a UE 115 (e.g., a UE 115-a) and a network entity 105 (e.g., a network entity 105-a), which may be examples of the corresponding devices as described with reference to FIG. 1. Although FIG. 2 is described herein with reference to a UE 115-a and a network entity 105-a, the described techniques may be used by one or more other wireless devices (e.g., another network entity 105, an IAB node) to determine a transmit power for a RACH message.

In some examples of the wireless communications system 200, a UE 115-a may establish a connection with a network entity 105-a by performing a RACH procedure. For example, the UE 115-a may transmit one or more RACH preambles 215 (e.g., a preamble 215-a, a preamble 215-b, a preamble 215-c) to the network entity 105-a via an uplink channel 205. In some examples, the preambles 215 may be preambles of a two-step or four-step RACH procedure. The UE 115-a may increase a transmit power of each subsequent preamble 215 based on a power ramping increment parameter. That is, if the UE 115-a does not receive a response to a preamble 215 from the network entity 105-a, the UE 115-a may assume that the network entity 105-a did not receive the preamble 215. The UE 115-a may therefore increase a transmit power of a subsequent preamble 215. Such techniques may be referred to as power ramping accumulated during preamble transmissions. The UE 115-a may transmit the preambles 215 via physical random access channel (PRACH) resources in one or more slots (e.g., HD and/or SBFD slots).

In some examples, the UE 115-a may monitor for a response 220 from the network entity 105-a via a downlink channel 210. For a four-step RACH procedure, the response 220 may be a random access response (RAR) message (e.g., msg2). For a two-step RACH procedure, the response 220 may be a FallbackRAR message.

The UE 115-a may transmit a PUSCH message 225 via the uplink channel 205 (e.g., after receiving the response 220). In some examples (e.g., for a four-step RACH procedure), the PUSCH message 225 may be a msg3. The UE 115-a may determine a transmit power for the PUSCH message 225 using Equation 1.

$${P}_{P U S C H} ( i , j , {q}_{d} , l ) = min \{ \begin{matrix}{P}_{CMAX , f , c} ( i ) \\ {P}_{0 PUSCH , b , f , c} ( j ) + 10 {log}_{10} ( {2}^{μ} * {M}_{RB , b , f , c}^{PUSCH} ( i ) ) + {α}_{b , f , c} ( j ) * {PL}_{b , f , c} ( {q}_{d} ) + {Δ}_{T F , b , f , c} + {f}_{b , f , c} ( i , l )\end{matrix} \qquad ( 1 )$$

With reference to Equation 1, i may be defined as a transmission occasion index, j may be set to 0 to indicate that the PUSCH message 225 is a random access related PUSCH (e.g., rather than a configured grant or other PUSCH), q_{d} may be an index of a downlink reference signal from a set of pathloss reference signals transmitted by the network entity 105-a, l may be a close loop power control index (e.g., with a single state 0), μ may be a subcarrier spacing associated with a channel between the UE 115-a and the network entity 105-a, and b may be a BWP of carrier f and serving or primary cell c (e.g., a BWP, carrier, and serving cell used by the UE 115-a to communicate with the network entity 105-a).

P_{CMAX,f,c}(i) may be a maximum transmit power for the UE 115-a to use to transmit uplink messages (e.g., the PUSCH message 225) to the network entity 105-a via the uplink channel 205 (e.g., in the carrier f and serving cell c). P_{0 PUSCH,b,f,c}(j) may represent an open loop power control parameter P₀ from a sum of a component P_{0 NOMINAL PUSCH,f,c}(j) and a component P_{0 UE PUSCH,b,f,c}(j). M_{RB,b,f,c}^{PUSCH}(i) may represent a bandwidth of a PUSCH resource assignment (e.g., expressed in a quantity of resource blocks (RBs)). Δ_{TE,b,f,c} may be a parameter related to a spectral efficiency of the serving cell. PL_{b,f,c}(q_{d}) may be a pathloss estimate (e.g., in decibels (dB)) of a downlink reference signal transmitted by the network entity 105-a with downlink reference signal index q_{d}·α_{b,f,c}(j) may be a pathloss compensation coefficient. f_{b,f,c}(i, l) may be a closed loop power control parameter.

The UE 115-a may use open loop power control and close loop power control to determine the transmit power for the PUSCH message 225. For example, the UE 115-a may receive a configuration of a set of open loop power control parameters (e.g., a set of P₀, α, and an indication of a downlink reference signal) to calculate a first portion (e.g., the open loop power control portion) of the power control formulas in Equation 1. The UE 115-a may calculate the closed loop power control f_{b,f,c}(i, l) using Equation 2.

$${f}_{b , f , c} ( 0 , l ) = Δ {P}_{r a m p u p , b , f , c} + {δ}_{msg 2 , b , f , c} \qquad ( 2 )$$

As described with reference to Equation 2, b may be a BWP of carrier f and serving or primary cell c (e.g., a BWP, carrier, and serving cell used by the UE 115-a to communicate with the network entity 105-a), l may be a close loop power control index (e.g., with a single state 0), and δ_{msg2,b,f,c} may be a power control parameter received via the response 220. ΔP_{rampup,b,f,c} may be defined according to Equation 3.

$$Δ {P}_{r a m p u p , b , f , c} = min [ \{ max ( 0 , {P}_{C M A X , f , c} - ( 10 {log}_{10} ( {2}^{μ} * {M}_{RB , b , f , c}^{P U S C H} ( 0 ) ) + {P}_{0 PUSCH , b , f , c} ( 0 ) + {α}_{b , f , c} ( 0 ) * P {L}_{c} + {Δ}_{T F , b , f , c} ( 0 ) + {δ}_{msg 2 , b , f , c} ) ) \} , Δ {P}_{rampuprequested , b , f , c} ] \qquad ( 3 )$$

ΔP_{rampuprequested,b,f,c} may be a total power ramp requested by higher layers of the UE 115-a. Closed loop power control of the PUSCH message 225 may accordingly depend on accumulated power ramping steps (e.g., power ramp increment sizes, a parameter PREAMBLE_POWER_RAMPING_STEP) for transmissions of the preambles 215 prior to the PUSCH message 225. The accumulated power ramping may increase for each preamble 215 transmission.

In an SBFD network, the UE 115-a may transmit the preambles 215 in either HD slots, SBFD slots, or a mix of HD and SBFD slots. In some examples, preambles 215 in HD slots may have a different (e.g., larger or smaller) power ramping increment size than preambles 215 in SBFD slots. That is, power control in HD and SBFD slots (e.g., or in a mix of slots) may be different due to cross link interference (CLI) and self-interference differences between SBFD and HD slots. Moreover, the UE 115-a may transmit the PUSCH message 225 in a slot with a first slot type (e.g., HD or SBFD) that is different than a second slot type of slots used to transmit one or more of the preambles 215. Thus, the UE 115-a may perform power control dependent on a quantity of preambles 215, a slot type of slots used to transmit the preambles 215, and a slot type of a slot used for the PUSCH message 225.

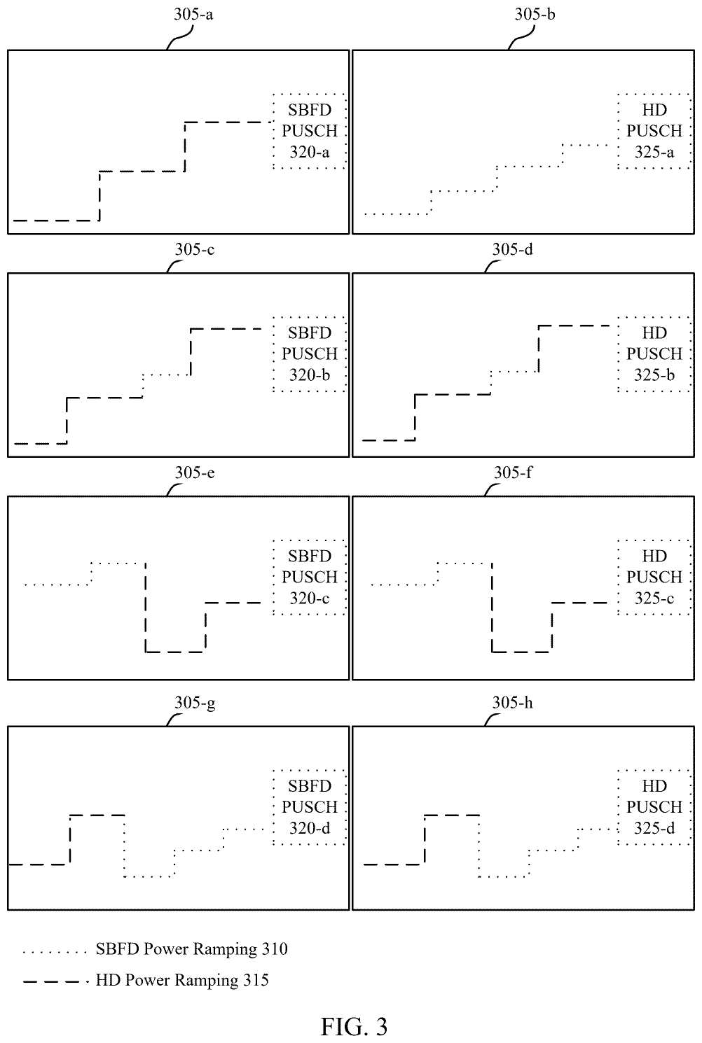

For example, as described with reference to FIG. 3, the UE 115-a may determine a value of ΔP_{rampup,b,f,c} based on a total quantity of preambles transmitted (e.g., and a power ramping increment parameter associated with the first slot type). That is, the UE 115-a may determine a first power ramping increment parameter associated with the first slot type of the slot used to transmit the PUSCH message 225. The UE 115-a may multiply the first power ramping increment parameter by the quantity of preambles 215 (e.g., preambles 215 transmitted via slots of the first slot type or via slots of the different slot type).

In some examples, the UE 115-a may determine a second power ramping increment parameter associated with the different slot type. The UE 115-a may multiply the first power ramping increment parameter by a first subset of the quantity of preambles 215 that are transmitted via slots of the first slot type, and may multiply the second power ramping increment parameter by a second subset of the quantity of preambles 215 that are transmitted via slots of the different slot type.

Additionally, or alternatively, the UE 115-a may determine a power ramping parameter based on a quantity of preambles transmitted via slots of the first slot type (e.g., and not preambles transmitted via slots of the different slot type). For example, the UE 115-a may multiply the first power ramping increment parameter by a subset of the quantity of preambles 215 that are transmitted via slots of the first slot type.

Additionally, or alternatively, the UE 115-a may determine a closed loop power control term based on a closed loop power control adjustment parameter (e.g., delta_ramp_adjustment or delta_duplex_adjustment) added to the closed loop power control equation. For example, the UE 115-a may calculate the closed loop power control parameter according to Equation 4.

$${f}_{b , f , c} ( 0 , l ) = Δ {P}_{r a m p u p , b , f , c} + {δ}_{msg 2 , b , f , c} + {δ}_{duplex\_adjustment} \qquad ( 4 )$$

The term δ_{duplex_adjustment} may be an overall adjustment term (e.g., a fixed adjustment term) applied by the UE 115-a when transmitting a PUSCH message 225 via the slot of the first slot type if one or more preambles 215 are transmitted via slots of the different slot type. The fixed adjustment term may be associated with the first slot type. Additionally, or alternatively, the UE 115-a may calculate dduplex_adjustment by multiplying an adjustment term associated with the first slot type by a subset of the quantity of preambles 215 that are transmitted via slots of the different slot type.

In some examples, the UE 115-a may reset a power ramping parameter upon switching slot types used to transmit preambles. For example, if the UE 115-a transmits a first preamble 215 via a HD slot and a subsequent preamble 215 via a SBFD slot, the UE 115-a may disregard power ramping accumulated in the HD slot and any prior slots and may set ΔP_{rampup,b,f,c} to 0.

In such examples, the wireless device may calculate the closed loop power control parameter based on a total quantity of preambles transmitted (e.g., in either HD or SBFD slots), based on a quantity of preambles transmitted via slots of the first slot type, or a total quantity of preambles transmitted after a latest power ramping reset. For example, the UE 115-a may use a power ramping increment parameter associated with the first slot type multiplied by the subset of the quantity of preambles 215 transmitted via slots of the first slot type and a power ramping increment parameter associated with the different slot type multiplied by a subset of the quantity of preambles 215 transmitted via slots of the different slot type to calculate the closed loop power control parameter. In some examples, the quantity of preambles and/or the subsets of the quantity of preambles may be tracked according to a power ramping counter. For example, the UE 115-a may increase the power ramping counter in response to re-transmitting a preamble. Additionally, or alternatively, the UE 115-a may use a power ramping increment parameter associated with the first slot type multiplied by the subset of the quantity of preambles 215 transmitted via slots of the first slot type to calculate the closed loop power control parameter. Additionally, or alternatively, the UE 115-a may use a power ramping increment parameter associated with a slot type of a last-transmitted preamble 215 multiplied by a subset of the quantity of preambles that were transmitted after a most recent power ramping reset.

In some examples, the wireless device may identify multiple closed loop power control states l, such as a closed loop power control state l=0 for PRACH transmissions via a non-SBFD slot (e.g., an HD slot) and a closed loop power control state l=1 for PRACH transmissions via an SBFD slot. The wireless device may calculate the closed loop power control parameter based on the closed loop power control state. For example, if the closed loop power control state is l=0, the UE 115-a may accumulate power ramping for preambles 215 transmitted via non-SBFD (e.g., HD) slots. If the closed loop power control state is 1, the UE 115-a may accumulate the PRACH power ramping for preambles 215 transmitted via SBFD slots.

In some examples, to determine whether δ_{msg2,b,f,c} applies to the closed loop power control state 0 or to the closed loop power control state 1, the UE 115-a may receive an indication (e.g., an explicit indication via downlink control information (DCI) or in an RAR grant such as the response 220) of the closed loop power control state. In some examples, the UE 115-a may receive an implicit indication of the closed loop power control state. For example, if a DCI or RAR grant (e.g., the response 220) indicates for the UE 115-a to transmit the PUSCH message 225 via a HD slot, the UE 115-a may assume a closed loop power control state of 0. If a DCI or RAR grant (e.g., the response 220) indicates for the UE 115-a to transmit the PUSCH message 225 via a SBFD slot, the UE 115-a may assume a closed loop power control state of 1.

FIG. 3 shows examples of power ramping diagrams 305 that support PUSCH power control for random access in SBFD networks in accordance with one or more aspects of the present disclosure. The power ramping diagrams 305 may implement or may be implemented by aspects of the wireless communications system 100 or the wireless communications system 200. For example, the power ramping diagrams 305 may be implemented by a wireless device such as a UE 115, a network entities 10, or an IAB node, which may be examples of the corresponding devices as described with reference to FIG. 1.

Although SBFD power ramping 310 is illustrated with reference to FIG. 3 as being smaller than HD power ramping 315, in some examples, SBFD power ramping 310 may be larger than HD power ramping 315. For example, power ramping accumulated via SBFD slots may be larger than, smaller than, or equal to power ramping accumulated via HD slots.

In some examples, as described with reference to FIG. 2, a wireless device (e.g., a UE 115, a network entity 105, an IAB node) may transmit one or more RACH preambles via PRACH resources in a corresponding one or more slots. The wireless device may transmit a PUSCH message in a subsequent slot. The one or more slots and the subsequent slot may be HD slots or SBFD slots.

In some examples, the wireless device may be restricted to perform random access procedures in either TDD slots (e.g., HD slots, non-SBFD slots) or in SBFD slots. That is, the wireless device may transmit both the preambles and the PUSCH message via slots of a same slot type (e.g., SBFD slots or HD slots). For example, for a four-step RACH procedure, the wireless device may transmit both msg1 (e.g., and any retransmissions of msg1) and msg3 via slots of a same slot type.

In some aspects, as illustrated with reference to a power ramping diagram 305-a and a power ramping diagram 305-b, the wireless device may transmit each of the preambles via slots with a different slot type than a slot used to transmit PUSCH. For example, as illustrated with reference to the power ramping diagram 305-a, the wireless device may perform HD power ramping 315 by transmitting one or more preambles via HD slots, and may transmit an SBFD PUSCH message 320-a (e.g., via an SBFD slot). Additionally, or alternatively, as illustrated with reference to the power ramping diagram 305-b, the wireless device may perform SBFD power ramping 310 by transmitting one or more preambles via SBFD slots, and may transmit a HD PUSCH message 325-a (e.g., via a HD slot). In such examples, retransmissions of the preambles may be restricted to a same slot type as an initial preamble transmission. PUSCH transmissions may not be restricted to the same slot type. For example, for a four-step RACH procedure, the wireless device may transmit each preamble transmission and retransmission (e.g., msg1) via slots of a first slot type, and may transmit msg3 via a slot of the first slot type or of a different slot type.

In such examples, the wireless device may calculate an accumulated power ramping based on an assumed ramping associated with the slot type of the PUSCH message. As an illustrative example, if the wireless device transmits five preambles via HD slots (e.g., associated with a HD power ramping increment parameter HD_ramp_step), the wireless device may calculate an accumulated power ramping for the SBFD PUSCH message 320-a by multiplying a SBFD power ramping increment parameter (e.g., FD_ramp_step) by five. Conversely, if the wireless device transmits five preambles via SBFD slots (e.g., associated with the SBFD power ramping increment parameter FD_ramp_step), the wireless device may calculate an accumulated power ramping for the HD PUSCH message 325-a by multiplying the HD power ramping increment parameter (e.g., HD_ramp_step) by five.

Additionally, or alternatively, the wireless device may add a closed loop power adjustment parameter (e.g., delta_ramp_adjustment) to an equation used to calculate a closed loop power control parameter (e.g., as described with reference to Equation 4). In some examples, the closed loop power adjustment parameter may be a fixed term that depends on the slot type of the slot used to transmit the PUSCH message and the slot type of the slots used to transmit the preambles. The closed loop power adjustment parameter may be defined according to a rule (e.g., a rule in a specification), indicated in system information (e.g., via a system information block (SIB)), or RRC configured (e.g., indicated or configured by another wireless device).

In some examples, the closed loop power adjustment parameter may be a fixed term multiplied by a quantity of preamble transmissions. That is, the closed loop power adjustment parameter may be applied for each preamble transmission. For example, as described with reference to the example above, if the wireless device transmits five preambles via HD slots, the wireless device may determine a transmit power for the SBFD PUSCH message 320-a by multiplying the closed loop power adjustment parameter δ_{duplex_adjustment} in the closed loop power control equation by five.

In some aspects, as illustrated with reference to a power ramping diagram 305-c and a power ramping diagram 305-d, the wireless device may transmit each of the preambles via slots with a combination of slot types. For example, as illustrated with reference to the power ramping diagram 305-c, the wireless device may perform HD power ramping 315 by transmitting one or more preambles via one or more HD slots and SBFD power ramping 310 by transmitting one or more preambles via one or more SBFD slots, and may transmit an SBFD PUSCH message 320-b (e.g., via an SBFD slot). Additionally, or alternatively, as illustrated with reference to the power ramping diagram 305-d, the wireless device may perform SBFD power ramping 310 by transmitting one or more preambles via one or more SBFD slots and HD power ramping 315 by transmitting one or more preambles via one or more HD slots, and may transmit a HD PUSCH message 325-b (e.g., via a HD slot).

In such examples, preamble transmissions (e.g., msg1 transmissions and retransmissions) and PUSCH transmissions (e.g., msg3 transmissions) may not be restricted to slot types. Additionally, or alternatively, the wireless device may transmit the PUSCH message (e.g., msg3) via a slot with a same slot type as a last successful preamble transmission (e.g., msg1).

In such examples, the wireless device may calculate a closed loop power control parameter based on all power ramping accumulations. As an illustrative example, if the wireless device transmits three preambles via HD slots and two preambles via SBFD slots, the wireless device may calculate the closed loop power control parameter by multiplying a HD power ramping increment parameter (e.g., power_ramp_step, HD_ramp_step) by three and by multiplying an SBFD power ramping increment parameter (e.g., power_ramp_step, FD_ramp_step) by two.

Additionally, or alternatively, the wireless device may calculate a closed loop power control parameter based on power ramping accumulated over all preamble transmissions according to the slot type of the slot used to transmit the PUSCH message. As an illustrative example, if the wireless device transmits three preambles via HD slots and two preambles via SBFD slots, the wireless device may calculate the closed loop power control parameter for an SBFD PUSCH message 320 by multiplying an SBFD power ramping increment parameter (e.g., power_ramp_step, FD_ramp_step) by five.

Additionally, or alternatively, the wireless device may calculate a closed loop power control parameter based on power ramping accumulated over preamble transmissions in slots of a same slot type as a slot used to transmit the PUSCH message. As an illustrative example, if the wireless device transmits three preambles via HD slots and two preambles via SBFD slots, the wireless device may calculate the closed loop power control parameter for an SBFD PUSCH message 320 by multiplying an SBFD power ramping increment parameter (e.g., power_ramp_step, FD_ramp_step) by two.

Additionally, or alternatively, the wireless device may apply a closed loop power adjustment parameter to a closed loop power control term, as described herein and with reference to Equation 4. The wireless device may apply the closed loop power adjustment parameter to each preamble transmitted in a slot with a different slot type than the slot used to transmit PUSCH. As an illustrative example, if the wireless device transmits three preambles via HD slots and two preambles via SBFD slots, the wireless device may calculate the closed loop power control parameter for a HD PUSCH message 325 by multiplying the closed loop power adjustment parameter (e.g., δ_{duplex_adjustment}) by two. In some examples, the closed loop power adjustment parameter may be a different between an SBFD power ramping increment parameter and a HD power ramping increment parameter. In such examples, the sign of the closed loop power adjustment parameter (e.g., positive or negative) may depend on the slot type of the slot used to transmit the PUSCH message.

In some aspects, as illustrated with reference to a power ramping diagram 305-e, a power ramping diagram 305-f, a power ramping diagram 305-g, and a power ramping diagram 305-h, the wireless device may transmit each of the preambles via slots with a combination of slot types, and the wireless device may perform a power reset in preamble transmissions due to shifting between HD and SBFD slots. That is, if a first preamble transmission has a different slot type than a subsequent preamble transmission, the wireless device may set a power ramping parameter to 0 prior to the subsequent preamble transmission. Accordingly, the wireless device may perform power ramping separately for preambles transmitted via slots of each slot type.

For example, as illustrated with reference to the power ramping diagram 305-e, the wireless device may perform SBFD power ramping 310 by transmitting one or more preambles via SBFD slots. The wireless device may perform a power ramping reset (e.g., setting a power ramping parameter to 0) before performing HD power ramping 315 by transmitting one or more preambles via HD slots. The wireless device may transmit an SBFD PUSCH message 320-c (e.g., via an SBFD slot). As illustrated with reference to the power ramping diagrams 305-f, 305-g, and 305-h, the wireless device may perform similar power ramping, power ramping reset, subsequent power ramping, and PUSCH transmissions for an HD PUSCH message 325-c, an SBFD PUSCH message 320-d, and an HD PUSCH message 325-d.

In such examples, preamble transmissions (e.g., msg1 transmissions and retransmissions) and PUSCH transmissions (e.g., msg3 transmissions) may not be restricted to slot types. Additionally, or alternatively, the wireless device may transmit the PUSCH message (e.g., msg3) via a slot with a same slot type as a last successful preamble transmission (e.g., msg1).

In some examples in which the wireless device performs a power ramping reset when switching between slot types for subsequent preamble transmissions, the wireless device may calculate a closed loop power control parameter based on all power ramping accumulations. As an illustrative example, if the wireless device transmits three preambles via HD slots and two preambles via SBFD slots, the wireless device may calculate the closed loop power control parameter by multiplying a HD power ramping increment parameter (e.g., power_ramp_step, HD_ramp_step) by three and by multiplying an SBFD power ramping increment parameter (e.g., power_ramp_step, FD_ramp_step) by two.

Additionally, or alternatively, the wireless device may calculate a closed loop power control parameter based on power ramping accumulated over preamble transmissions in slots of a same slot type as a slot used to transmit the PUSCH message. As an illustrative example, if the wireless device transmits three preambles via HD slots and two preambles via SBFD slots, the wireless device may calculate the closed loop power control parameter for an SBFD PUSCH message 320 by multiplying an SBFD power ramping increment parameter (e.g., power_ramp_step, FD_ramp_step) by two.

Additionally, or alternatively, the wireless device may calculate a closed loop power control parameter based on counting power ramping accumulated over last preamble transmissions that occurred after a last power ramping reset (e.g., preambles transmitted after a latest power ramping reset of the RACH procedure). As an illustrative example, if the wireless device transmits three preambles via HD slots, performs a power ramping reset, and transmits two preambles via SBFD slots, the wireless device may calculate the closed loop power control parameter by multiplying an SBFD power ramping increment parameter (e.g., power_ramp_step, FD_ramp_step) by two (e.g., corresponding to the two preamble transmissions that occurred after the last power reset).

Additionally, or alternatively, the wireless device may apply a closed loop power adjustment parameter to a closed loop power control term, as described herein and with reference to Equation 4. The wireless device may apply the closed loop power adjustment parameter to each preamble transmitted in a slot with a different slot type than the slot used to transmit PUSCH. As an illustrative example, if the wireless device transmits three preambles via HD slots and two preambles via SBFD slots, the wireless device may calculate the closed loop power control parameter for a HD PUSCH message 325 by multiplying the closed loop power adjustment parameter (e.g., δ_{duplex_adjustment}) by two. In some examples, the closed loop power adjustment parameter may be a different between an SBFD power ramping increment parameter and a HD power ramping increment parameter. In such examples, the sign of the closed loop power adjustment parameter (e.g., positive or negative) may depend on the slot type of the slot used to transmit the PUSCH message.

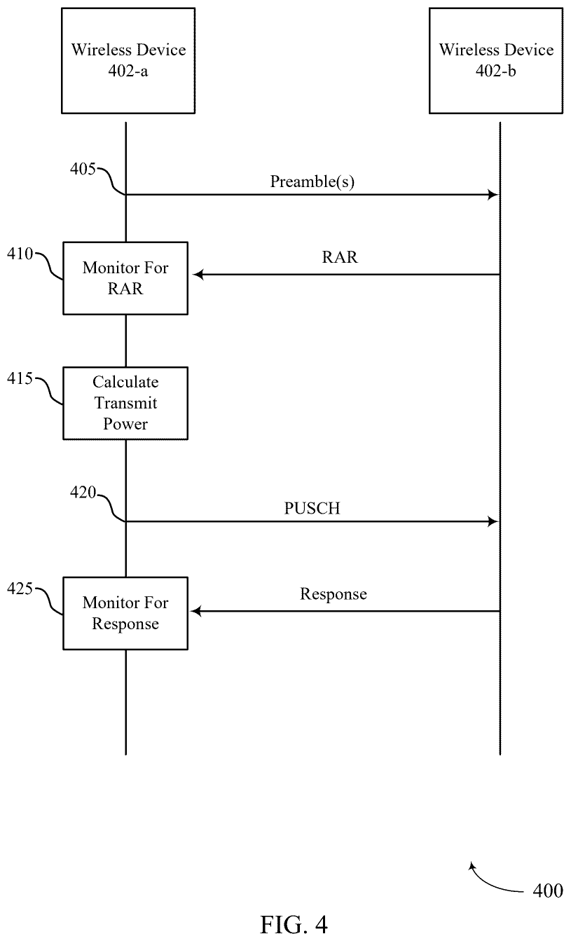

FIG. 4 shows an example of a process flow 400 that supports PUSCH power control for random access in SBFD networks in accordance with one or more aspects of the present disclosure. The process flow 400 may implement or may be implemented by aspects of the wireless communications system 100, the wireless communications system 200, or the power ramping diagrams 305. For example, the process flow 400 may be implemented by a wireless device 402-a and a wireless device 402-b, which may be examples of UEs 115, network entities 105, or IAB nodes as described with reference to FIG. 1.

In the following description of the process flow 400, the operations between the wireless device 402-a and the wireless device 402-b may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time.

At 405, the wireless device 402-a may output, to the wireless device 402-b, one or more preambles (e.g., RACH preambles). The one or more preambles may be examples of a preamble for msg1 or msgA of a four-step or two-step RACH procedure, respectively. In some examples, the wireless device 402-a may output a quantity of RACH preambles via corresponding PRACH resources in a corresponding quantity of slots, and each slot of the corresponding quantity of slots may be either a SBFD slot or a HD slot. For example, a first subset of the corresponding quantity of slots may be SBFD slots and a second subset of the corresponding quantity of slots may be HD slots.

In some examples, the wireless device 402-a may perform power ramping while outputting the quantity of RACH preambles. For example, the wireless device 402-a may increase a power ramping parameter of each subsequent preamble transmission based on a power ramping increment parameter associated with a slot type (e.g., SBFD, HD) of the preamble transmission. In some examples, if a first preamble transmission is in a first slot with a slot type and a subsequent preamble transmission is in a slot with a second slot type (e.g., different from the slot type of the first slot), the wireless device 402-a may reset the power ramping parameter such that the subsequent preamble is transmitted with a power ramping parameter set to 0.

At 410, the wireless device 402-a may monitor for a response to the RACH preambles (e.g., an RAR, an RAR grant, msg2, a FallbackRAR) from the wireless device 402-b. The response may indicate one or more power control parameters for the wireless device 402-a to use to transmit a PUSCH message to the wireless device 402-b. In some examples, the response (e.g., or another message, such as a DCI) may include an indication of a closed loop power control state (e.g., a HD closed loop power control state or a SBFD closed loop power control state).

At 415, the wireless device 402-a may calculate a transmit power for the PUSCH message using one or more of Equations 1 through 4 described herein. For example, the wireless device 402-a may calculate a closed loop power control parameter for the PUSCH message based on the quantity of preambles transmitted and a first slot type (e.g., HD or SBFD) of a slot that the wireless device 402-a may use to transmit the PUSCH message.

In some examples, the wireless device 402-a may calculate the closed loop power control parameter based on a multiplication of a power ramping increment parameter associated with the first slot type. For example, the wireless device 402-a may multiply the power ramping increment parameter associated with the first slot type by the total quantity of preamble transmissions, or by a first subset of the quantity of preamble transmissions that were transmitted via a first subset of the quantity of slots that are associated with the first slot type.

In some examples, the wireless device 402-a may calculate the closed loop power control parameter based on a multiplication of a power ramping increment parameter associated with the first slot type and a multiplication of a power ramping increment parameter associated with a different slot type. For example, the wireless device 402-a may multiply the power ramping increment parameter associated with the first slot type by a first subset of the quantity of preamble transmissions that were transmitted via a first subset of the quantity of slots that are associated with the first slot type, and may multiply the power ramping increment parameter associated with the different slot type by a second subset of the quantity of preamble transmissions that were transmitted via a second subset of the quantity of slots that are associated with the different slot type.

In some examples, the wireless device 402-a may calculate the closed loop power control parameter based on a closed loop power adjustment parameter. The closed loop power adjustment parameter may be fixed according to a rule, indicated via system information (e.g., from the wireless device 402-b), or indicated or configured via RRC (e.g., from the wireless device 402-b). In some examples, the wireless device 402-a may add the closed loop power adjustment parameter to the closed loop power control parameter. Additionally, or alternatively, the wireless device may perform a multiplication of the closed loop power adjustment parameter by a quantity of preambles of a second subset of the quantity of preambles that were transmitted via a second subset of slots that are associated with a slot type different from the first slot type.

In some examples, if the wireless device 402-a resets the power ramping parameter to 0, the wireless device 402-a may calculate the closed loop power control parameter by multiplying a power ramping increment parameter associated with the second slot type by a quantity that corresponds to a quantity of preambles that were transmitted after a most recent power ramping reset (e.g., after the power ramping parameter is set to 0).

In some examples, the wireless device 402-a may calculate the closed loop power control parameter based on a closed loop power control state. For example, one or more parameters used by the wireless device 402-a to calculate the closed loop power control parameter may depend on the closed loop power control state. The wireless device 402-a may use the closed loop power control state indicated via the response or via DCI. Additionally, or alternatively, the wireless device 402-a may use a closed loop power control state that corresponds to the first slot type (e.g., the slot type of the slot used to transmit the PUSCH message).

At 420, the wireless device may transmit the PUSCH message to the wireless device 402-b using the calculated transmit power via the slot of the first slot type. In some examples, the wireless device 402-a may transmit the PUSCH message via resources indicated in the response (e.g., the RAR grant).

At 425, the wireless device 402-a may monitor for a response to the PUSCH message from the wireless device 402-b. The response may be an additional message of the RACH procedure (e.g., msg4). In some examples, the response may be to both of the PUSCH message and the one or more preambles.

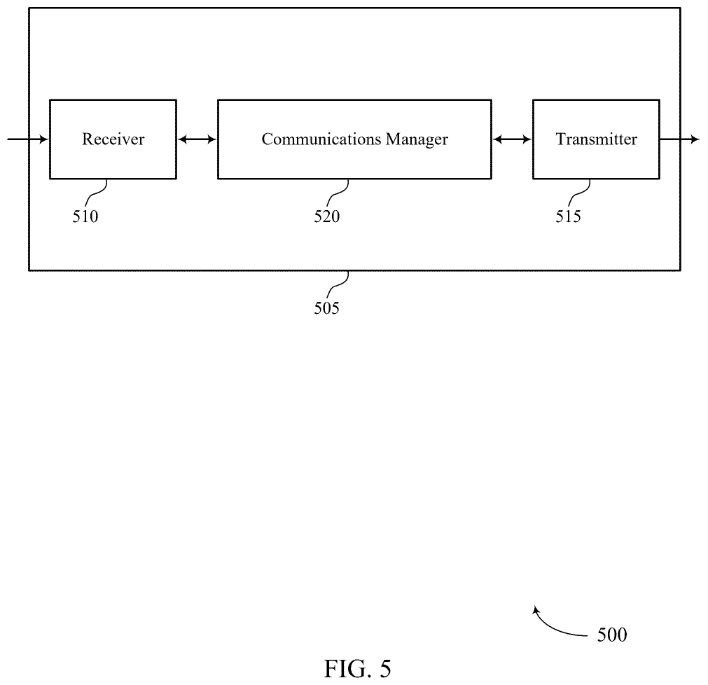

FIG. 5 shows a block diagram 500 of a device 505 that supports PUSCH power control for random access in SBFD networks in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations or components thereof may be examples of means for performing various aspects of PUSCH power control for random access in SBFD networks as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting one or more preambles of a random access channel procedure via a corresponding one or more slots. The communications manager 520 is capable of, configured to, or operable to support a means for transmitting a PUSCH message of the random access channel procedure in an additional slot using a transmit power based on a quantity of preambles of the one or more preambles and on a slot type of the additional slot, the slot type including a HD slot or a SBFD slot. The communications manager 520 is capable of, configured to, or operable to support a means for monitoring for a message responsive to the one or more preambles, the PUSCH message, or both.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for PUSCH power control in SBFD networks, which may result in more efficient utilization of communication resources.

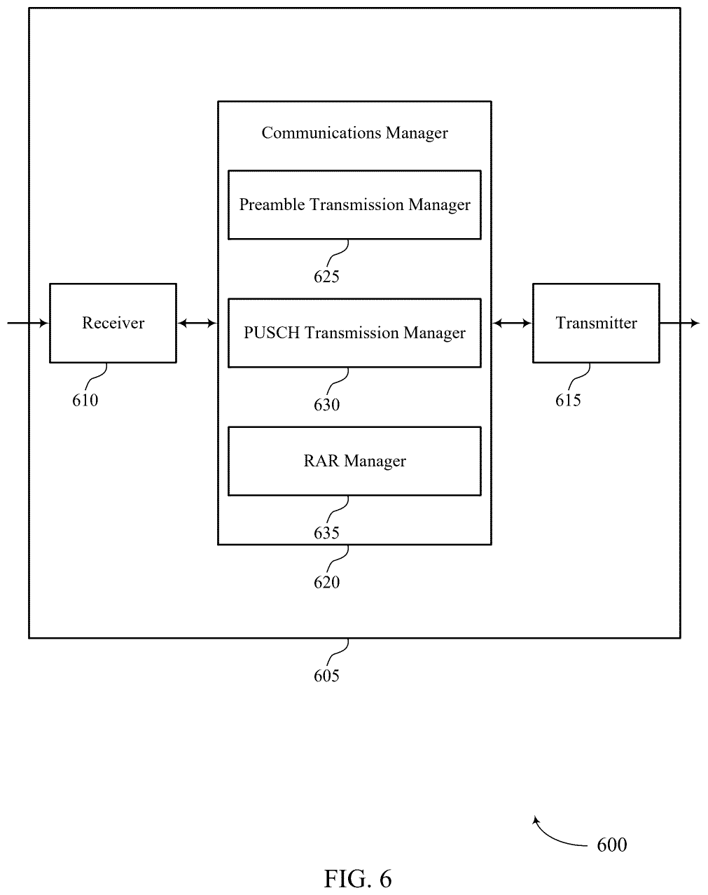

FIG. 6 shows a block diagram 600 of a device 605 that supports PUSCH power control for random access in SBFD networks in accordance with one or more aspects of the present disclosure. The device 605 may be an example of aspects of a device 505 or a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of PUSCH power control for random access in SBFD networks as described herein. For example, the communications manager 620 may include a preamble transmission manager 625, an PUSCH transmission manager 630, a RAR manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The preamble transmission manager 625 is capable of, configured to, or operable to support a means for transmitting one or more preambles of a random access channel procedure via a corresponding one or more slots. The PUSCH transmission manager 630 is capable of, configured to, or operable to support a means for transmitting a PUSCH message of the random access channel procedure in an additional slot using a transmit power based on a quantity of preambles of the one or more preambles and on a slot type of the additional slot, the slot type including a HD slot or a SBFD slot. The RAR manager 635 is capable of, configured to, or operable to support a means for monitoring for a message responsive to the one or more preambles, the PUSCH message, or both.

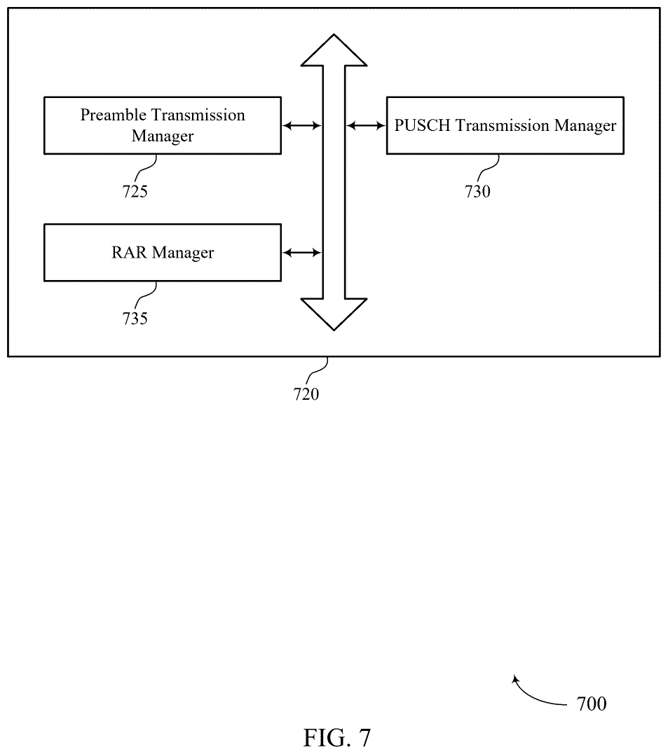

FIG. 7 shows a block diagram 700 of a communications manager 720 that supports PUSCH power control for random access in SBFD networks in accordance with one or more aspects of the present disclosure. The communications manager 720 may be an example of aspects of a communications manager 520, a communications manager 620, or both, as described herein. The communications manager 720, or various components thereof, may be an example of means for performing various aspects of PUSCH power control for random access in SBFD networks as described herein. For example, the communications manager 720 may include a preamble transmission manager 725, an PUSCH transmission manager 730, a RAR manager 735, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications in accordance with examples as disclosed herein. The preamble transmission manager 725 is capable of, configured to, or operable to support a means for transmitting one or more preambles of a random access channel procedure via a corresponding one or more slots. The PUSCH transmission manager 730 is capable of, configured to, or operable to support a means for transmitting a PUSCH message of the random access channel procedure in an additional slot using a transmit power based on a quantity of preambles of the one or more preambles and on a slot type of the additional slot, the slot type including a HD slot or a SBFD slot. The RAR manager 735 is capable of, configured to, or operable to support a means for monitoring for a message responsive to the one or more preambles, the PUSCH message, or both.

In some examples, the transmit power associated with transmission of the PUSCH message is based on a closed loop power control parameter. In some examples, a value of the closed loop power control parameter is based on a multiplication of a power ramping increment parameter associated with the slot type of the additional slot by the quantity of preambles of the one or more preambles. In some examples, the quantity of preambles corresponds to a total quantity of preambles transmitted by the wireless device for the random access channel procedure.

In some examples, the transmit power associated with transmission of the PUSCH message is based on a closed loop power control parameter. In some examples, a value of the closed loop power control parameter is based on a multiplication of a power ramping increment parameter associated with the slot type of the additional slot by the quantity of preambles of the one or more preambles. In some examples, the quantity of preambles corresponds to a quantity of preambles transmitted by the wireless device for the random access channel procedure via a subset of slots of the one or more slots that are associated with a same slot type as the slot type of the additional slot.

In some examples, the transmit power associated with transmission of the PUSCH message is based on a closed loop power control parameter. In some examples, a value of the closed loop power control parameter is based on a multiplication of a power ramping increment parameter associated with the slot type of the additional slot by a first quantity of a first subset of the quantity of preambles and a multiplication of a power ramping increment parameter associated with a slot type different from the slot type of the additional slot by a second quantity of a second subset of the quantity of preambles. In some examples, the first subset of the quantity of preambles corresponds to a quantity of preambles transmitted by the wireless device for the random access channel procedure via a first set of slots of the one or more slots that are associated with a same slot type as the slot type of the additional slot. In some examples, the second subset of the quantity of preambles corresponds to a quantity of preambles transmitted by the wireless device for the random access channel procedure via a second set of slots of the one or more slots that are associated with the slot type that is different than the slot type of the additional slot.

In some examples, a closed loop power control parameter is based on a closed loop power adjustment parameter associated with the slot type of the additional slot. In some examples, the transmit power is based on the closed loop power control parameter.

In some examples, the closed loop power adjustment parameter is multiplied by the quantity of preambles of the one or more preambles. In some examples, the quantity of preambles corresponds to a quantity of preambles transmitted by the wireless device for the random access channel procedure via a subset of slots of the one or more slots that are associated with a slot type that is different from the slot type of the additional slot.

In some examples, the transmit power associated with transmission of the PUSCH message is based on a closed loop power control parameter. In some examples, a value of the closed loop power control parameter is based on a power ramping parameter that is set to zero upon transmission of a first preamble of the one or more preambles in a first slot of the one or more slots associated with a first slot type and transmission of a subsequent preamble of the one or more preambles in a second slot of the one or more slots associated with a second slot type different from the first slot type.

In some examples, the transmit power associated with transmission of the PUSCH message is based on a closed loop power control parameter. In some examples, a value of the closed loop power control parameter is based on a multiplication of a power ramping increment parameter associated with the second slot type by the quantity of preambles of the one or more preambles. In some examples, the quantity of preambles corresponds to a quantity of preambles transmitted by the wireless device for the random access channel procedure via a subset of slots of the one or more slots associated with the second slot type after the power ramping parameter is set to zero.

In some examples, the transmit power is based on a closed loop power control state associated with the slot type of the additional slot.

In some examples, the RAR manager 735 is capable of, configured to, or operable to support a means for receiving the message responsive to the one or more preambles, the PUSCH message, or both, where the message includes an indication of the closed loop power control state.

In some examples, the closed loop power control state is based on the slot type of the additional slot.

In some examples, to support transmitting the one or more preambles, the preamble transmission manager 725 is capable of, configured to, or operable to support a means for transmitting the one or more preambles via a corresponding one or more physical random access channel resources of the one or more slots.

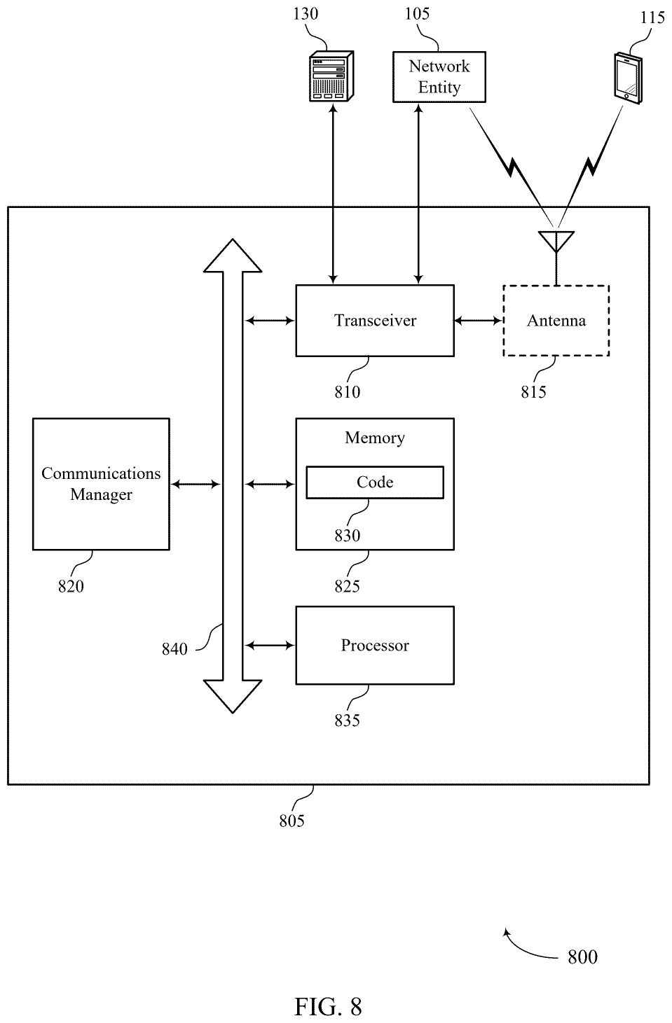

FIG. 8 shows a diagram of a system 800 including a device 805 that supports PUSCH power control for random access in SBFD networks in accordance with one or more aspects of the present disclosure. The device 805 may be an example of or include components of a device 505, a device 605, or a network entity 105 as described herein. The device 805 may communicate with other network devices or network equipment such as one or more of the network entities 105, UEs 115, or any combination thereof. The communications may include communications over one or more wired interfaces, over one or more wireless interfaces, or any combination thereof. The device 805 may include components that support outputting and obtaining communications, such as a communications manager 820, a transceiver 810, one or more antennas 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., communication link(s) 125, backhaul communication link(s) 120, a midhaul communication link 162, a fronthaul communication link 168).

The at least one memory 825 may include RAM, ROM, or any combination thereof. The at least one memory 825 may store computer-readable, computer-executable, or processor-executable code, such as the code 830. The code 830 may include instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may include, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting PUSCH power control for random access in SBFD networks). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825).

In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with one or more other network entities 105, and may include a controller or scheduler for controlling communications with UEs 115 (e.g., in cooperation with the one or more other network devices). In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for transmitting one or more preambles of a random access channel procedure via a corresponding one or more slots. The communications manager 820 is capable of, configured to, or operable to support a means for transmitting a PUSCH message of the random access channel procedure in an additional slot using a transmit power based on a quantity of preambles of the one or more preambles and on a slot type of the additional slot, the slot type including a HD slot or a SBFD slot. The communications manager 820 is capable of, configured to, or operable to support a means for monitoring for a message responsive to the one or more preambles, the PUSCH message, or both.

By including or configuring the communications manager 820 in accordance with examples as described herein, the device 805 may support techniques for PUSCH power control in SBFD networks, which may result in improved communication reliability, reduced latency, more efficient utilization of communication resources, and improved coordination between devices.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of PUSCH power control for random access in SBFD networks as described herein, or the at least one processor 835 and the at least one memory 825 may be otherwise configured to, individually or collectively, perform or support such operations.

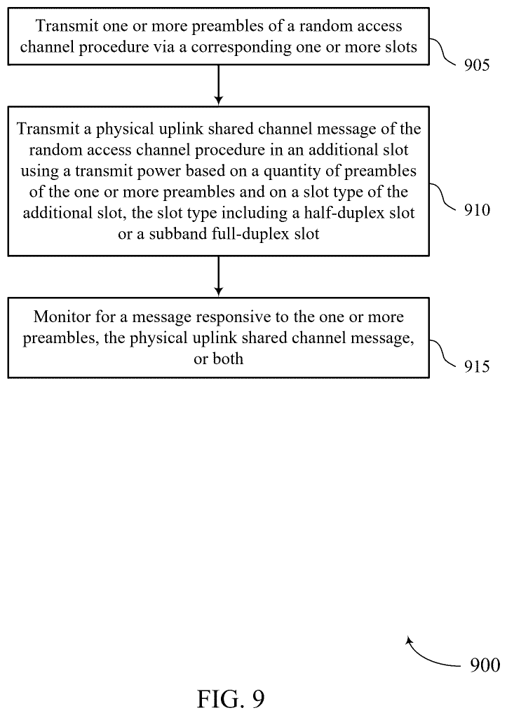

FIG. 9 shows a flowchart illustrating a method 900 that supports PUSCH power control for random access in SBFD networks in accordance with one or more aspects of the present disclosure. The operations of the method 900 may be implemented by a network entity or its components as described herein. For example, the operations of the method 900 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 905, the method may include transmitting one or more preambles of a random access channel procedure via a corresponding one or more slots. The operations of 905 may be performed in accordance with examples as disclosed herein. In some examples, aspects of the operations of 905 may be performed by a preamble transmission manager 725 as described with reference to FIG. 7.

At 910, the method may include transmitting a PUSCH message of the random access channel procedure in an additional slot using a transmit power based on a quantity of preambles of the one or more preambles and on a slot type of the additional slot, the slot type including a HD slot or a SBFD slot. The operations of 910 may be performed in accordance with examples as disclosed herein. In some examples, aspects of the operations of 910 may be performed by an PUSCH transmission manager 730 as described with reference to FIG. 7.

At 915, the method may include monitoring for a message responsive to the one or more preambles, the PUSCH message, or both. The operations of 915 may be performed in accordance with examples as disclosed herein. In some examples, aspects of the operations of 915 may be performed by a RAR manager 735 as described with reference to FIG. 7.

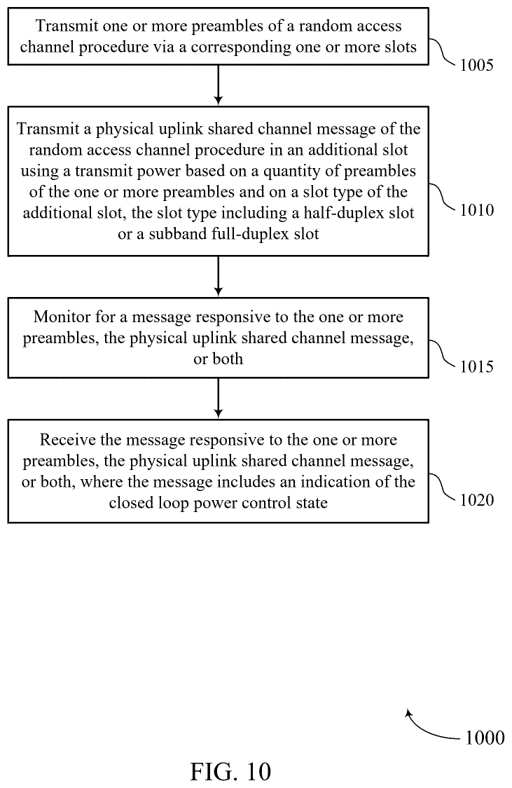

FIG. 10 shows a flowchart illustrating a method 1000 that supports PUSCH power control for random access in SBFD networks in accordance with one or more aspects of the present disclosure. The operations of the method 1000 may be implemented by a network entity or its components as described herein. For example, the operations of the method 1000 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1005, the method may include transmitting one or more preambles of a random access channel procedure via a corresponding one or more slots. The operations of 1005 may be performed in accordance with examples as disclosed herein. In some examples, aspects of the operations of 1005 may be performed by a preamble transmission manager 725 as described with reference to FIG. 7.

At 1010, the method may include transmitting a PUSCH message of the random access channel procedure in an additional slot using a transmit power based on a quantity of preambles of the one or more preambles and on a slot type of the additional slot, the slot type including a HD slot or a SBFD slot. The operations of 1010 may be performed in accordance with examples as disclosed herein. In some examples, aspects of the operations of 1010 may be performed by an PUSCH transmission manager 730 as described with reference to FIG. 7.

At 1015, the method may include monitoring for a message responsive to the one or more preambles, the PUSCH message, or both. The operations of 1015 may be performed in accordance with examples as disclosed herein. In some examples, aspects of the operations of 1015 may be performed by a RAR manager 735 as described with reference to FIG. 7.

At 1020, the method may include receiving the message responsive to the one or more preambles, the PUSCH message, or both, where the message includes an indication of the closed loop power control state. The operations of 1020 may be performed in accordance with examples as disclosed herein. In some examples, aspects of the operations of 1020 may be performed by a RAR manager 735 as described with reference to FIG. 7.

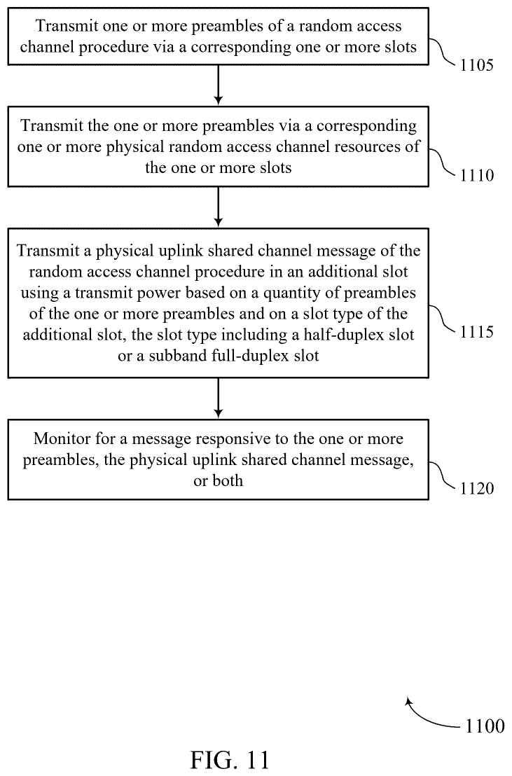

FIG. 11 shows a flowchart illustrating a method 1100 that supports PUSCH power control for random access in SBFD networks in accordance with one or more aspects of the present disclosure. The operations of the method 1100 may be implemented by a network entity or its components as described herein. For example, the operations of the method 1100 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1105, the method may include transmitting one or more preambles of a random access channel procedure via a corresponding one or more slots. The operations of 1105 may be performed in accordance with examples as disclosed herein. In some examples, aspects of the operations of 1105 may be performed by a preamble transmission manager 725 as described with reference to FIG. 7.

At 1110, the method may include transmitting the one or more preambles via a corresponding one or more physical random access channel resources of the one or more slots. The operations of 1110 may be performed in accordance with examples as disclosed herein. In some examples, aspects of the operations of 1110 may be performed by a preamble transmission manager 725 as described with reference to FIG. 7.

At 1115, the method may include transmitting a PUSCH message of the random access channel procedure in an additional slot using a transmit power based on a quantity of preambles of the one or more preambles and on a slot type of the additional slot, the slot type including a HD slot or a SBFD slot. The operations of 1115 may be performed in accordance with examples as disclosed herein. In some examples, aspects of the operations of 1115 may be performed by an PUSCH transmission manager 730 as described with reference to FIG. 7.

At 1120, the method may include monitoring for a message responsive to the one or more preambles, the PUSCH message, or both. The operations of 1120 may be performed in accordance with examples as disclosed herein. In some examples, aspects of the operations of 1120 may be performed by a RAR manager 735 as described with reference to FIG. 7.

The following provides an overview of aspects of the present disclosure:

Aspect 1: A method for wireless communications by a wireless device, comprising: transmitting one or more preambles of a RACH procedure via a corresponding one or more slots; transmitting a PUSCH message of the RACH procedure in an additional slot using a transmit power based at least in part on a quantity of preambles of the one or more preambles and on a slot type of the additional slot, the slot type comprising a HD slot or a SBFD slot; and monitoring for a message responsive to the one or more preambles, the PUSCH message, or both.

Aspect 2: The method of aspect 1, wherein the transmit power associated with transmission of the PUSCH message is based at least in part on a closed loop power control parameter, a value of the closed loop power control parameter is based at least in part on a multiplication of a power ramping increment parameter associated with the slot type of the additional slot by the quantity of preambles of the one or more preambles, and the quantity of preambles corresponds to a total quantity of preambles transmitted by the wireless device for the RACH procedure.

Aspect 3: The method of any of aspects 1 through 2, wherein the transmit power associated with transmission of the PUSCH message is based at least in part on a closed loop power control parameter, a value of the closed loop power control parameter is based at least in part on a multiplication of a power ramping increment parameter associated with the slot type of the additional slot by the quantity of preambles of the one or more preambles, and the quantity of preambles corresponds to a quantity of preambles transmitted by the wireless device for the RACH procedure via a subset of slots of the one or more slots that are associated with a same slot type as the slot type of the additional slot.

Aspect 4: The method of any of aspects 1 through 3, wherein the transmit power associated with transmission of the PUSCH message is based at least in part on a closed loop power control parameter, a value of the closed loop power control parameter is based at least in part on a multiplication of a power ramping increment parameter associated with the slot type of the additional slot by a first quantity of a first subset of the quantity of preambles and a multiplication of a power ramping increment parameter associated with a slot type different from the slot type of the additional slot by a second quantity of a second subset of the quantity of preambles, the first subset of the quantity of preambles corresponds to a quantity of preambles transmitted by the wireless device for the RACH procedure via a first set of slots of the one or more slots that are associated with a same slot type as the slot type of the additional slot, and the second subset of the quantity of preambles corresponds to a quantity of preambles transmitted by the wireless device for the RACH procedure via a second set of slots of the one or more slots that are associated with the slot type that is different than the slot type of the additional slot.

Aspect 5: The method of any of aspects 1 through 4, wherein a closed loop power control parameter is based at least in part on a closed loop power adjustment parameter associated with the slot type of the additional slot, and the transmit power is based at least in part on the closed loop power control parameter.

Aspect 6: The method of aspect 5, wherein the closed loop power adjustment parameter is multiplied by the quantity of preambles of the one or more preambles, and the quantity of preambles corresponds to a quantity of preambles transmitted by the wireless device for the RACH procedure via a subset of slots of the one or more slots that are associated with a slot type that is different from the slot type of the additional slot.

Aspect 7: The method of any of aspects 1 through 6, wherein the transmit power associated with transmission of the PUSCH message is based at least in part on a closed loop power control parameter, and a value of the closed loop power control parameter is based at least in part on a power ramping parameter that is set to zero upon transmission of a first preamble of the one or more preambles in a first slot of the one or more slots associated with a first slot type and transmission of a subsequent preamble of the one or more preambles in a second slot of the one or more slots associated with a second slot type different from the first slot type.

Aspect 8: The method of aspect 7, wherein the transmit power associated with transmission of the PUSCH message is based at least in part on a closed loop power control parameter, a value of the closed loop power control parameter is based at least in part on a multiplication of a power ramping increment parameter associated with the second slot type by the quantity of preambles of the one or more preambles, and the quantity of preambles corresponds to a quantity of preambles transmitted by the wireless device for the RACH procedure via a subset of slots of the one or more slots associated with the second slot type after the power ramping parameter is set to zero.

Aspect 9: The method of any of aspects 1 through 8, wherein the transmit power is based at least in part on a closed loop power control state associated with the slot type of the additional slot.

Aspect 10: The method of aspect 9, further comprising: receiving the message responsive to the one or more preambles, the PUSCH message, or both, wherein the message comprises an indication of the closed loop power control state.

Aspect 11: The method of any of aspects 9 through 10, wherein the closed loop power control state is based at least in part on the slot type of the additional slot.

Aspect 12: The method of any of aspects 1 through 11, wherein transmitting the one or more preambles comprises: transmitting the one or more preambles via a corresponding one or more PRACH resources of the one or more slots.

Aspect 13: A wireless device for wireless communications, comprising one or more memories storing processor-executable code, and one or more processors coupled with the one or more memories and individually or collectively operable to execute the code to cause the wireless device to perform a method of any of aspects 1 through 12.

Aspect 14: A wireless device for wireless communications, comprising at least one means for performing a method of any of aspects 1 through 12.

Aspect 15: A non-transitory computer-readable medium storing code for wireless communications, the code comprising instructions executable by one or more processors to perform a method of any of aspects 1 through 12.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
transmit one or more preambles of a random access channel procedure via a corresponding one or more slots;
transmit a physical uplink shared channel message of the random access channel procedure in an additional slot using a transmit power based at least in part on a quantity of preambles of the one or more preambles and on a slot type of the additional slot, the slot type comprising a half-duplex slot or a subband full-duplex slot; and
monitor for a message responsive to the one or more preambles, the physical uplink shared channel message, or both.

2. The wireless device of claim 1, wherein the transmit power associated with transmission of the physical uplink shared channel message is based at least in part on a closed loop power control parameter,
wherein a value of the closed loop power control parameter is based at least in part on a multiplication of a power ramping increment parameter associated with the slot type of the additional slot by the quantity of preambles of the one or more preambles, and
wherein the quantity of preambles corresponds to a total quantity of preambles transmitted by the wireless device for the random access channel procedure.

3. The wireless device of claim 1, wherein the transmit power associated with transmission of the physical uplink shared channel message is based at least in part on a closed loop power control parameter,
wherein a value of the closed loop power control parameter is based at least in part on a multiplication of a power ramping increment parameter associated with the slot type of the additional slot by the quantity of preambles of the one or more preambles, and
wherein the quantity of preambles corresponds to a quantity of preambles transmitted by the wireless device for the random access channel procedure via a subset of slots of the one or more slots that are associated with a same slot type as the slot type of the additional slot.

4. The wireless device of claim 1, wherein the transmit power associated with transmission of the physical uplink shared channel message is based at least in part on a closed loop power control parameter,
wherein a value of the closed loop power control parameter is based at least in part on a multiplication of a power ramping increment parameter associated with the slot type of the additional slot by a first quantity of a first subset of the quantity of preambles and a multiplication of a power ramping increment parameter associated with a slot type different from the slot type of the additional slot by a second quantity of a second subset of the quantity of preambles,
wherein the first subset of the quantity of preambles corresponds to a quantity of preambles transmitted by the wireless device for the random access channel procedure via a first set of slots of the one or more slots that are associated with a same slot type as the slot type of the additional slot, and
wherein the second subset of the quantity of preambles corresponds to a quantity of preambles transmitted by the wireless device for the random access channel procedure via a second set of slots of the one or more slots that are associated with the slot type that is different than the slot type of the additional slot.

5. The wireless device of claim 1, wherein a closed loop power control parameter is based at least in part on a closed loop power adjustment parameter associated with the slot type of the additional slot, and
wherein the transmit power is based at least in part on the closed loop power control parameter.

6. The wireless device of claim 5, wherein the closed loop power adjustment parameter is multiplied by the quantity of preambles of the one or more preambles, and
wherein the quantity of preambles corresponds to a quantity of preambles transmitted by the wireless device for the random access channel procedure via a subset of slots of the one or more slots that are associated with a slot type that is different from the slot type of the additional slot.

7. The wireless device of claim 1, wherein the transmit power associated with transmission of the physical uplink shared channel message is based at least in part on a closed loop power control parameter, and
wherein a value of the closed loop power control parameter is based at least in part on a power ramping parameter that is set to zero upon transmission of a first preamble of the one or more preambles in a first slot of the one or more slots associated with a first slot type and transmission of a subsequent preamble of the one or more preambles in a second slot of the one or more slots associated with a second slot type different from the first slot type.

8. The wireless device of claim 7, wherein the transmit power associated with transmission of the physical uplink shared channel message is based at least in part on a closed loop power control parameter,
wherein a value of the closed loop power control parameter is based at least in part on a multiplication of a power ramping increment parameter associated with the second slot type by the quantity of preambles of the one or more preambles, and
wherein the quantity of preambles corresponds to a quantity of preambles transmitted by the wireless device for the random access channel procedure via a subset of slots of the one or more slots associated with the second slot type after the power ramping parameter is set to zero.

9. The wireless device of claim 1, wherein the transmit power is based at least in part on a closed loop power control state associated with the slot type of the additional slot.

10. The wireless device of claim 9, wherein the one or more processors are individually or collectively further operable to execute the code to cause the wireless device to:
receive the message responsive to the one or more preambles, the physical uplink shared channel message, or both, wherein the message comprises an indication of the closed loop power control state.

11. The wireless device of claim 9, wherein the closed loop power control state is based at least in part on the slot type of the additional slot.

12. The wireless device of claim 1, wherein, to transmit the one or more preambles, the one or more processors are individually or collectively operable to execute the code to cause the wireless device to:
transmit the one or more preambles via a corresponding one or more physical random access channel resources of the one or more slots.

13. A method for wireless communications by a wireless device, comprising:
transmitting one or more preambles of a random access channel procedure via a corresponding one or more slots;
transmitting a physical uplink shared channel message of the random access channel procedure in an additional slot using a transmit power based at least in part on a quantity of preambles of the one or more preambles and on a slot type of the additional slot, the slot type comprising a half-duplex slot or a subband full-duplex slot; and
monitoring for a message responsive to the one or more preambles, the physical uplink shared channel message, or both.

14. The method of claim 13, wherein the transmit power associated with transmission of the physical uplink shared channel message is based at least in part on a closed loop power control parameter,
wherein a value of the closed loop power control parameter is based at least in part on a multiplication of a power ramping increment parameter associated with the slot type of the additional slot by the quantity of preambles of the one or more preambles, and
wherein the quantity of preambles corresponds to a total quantity of preambles transmitted by the wireless device for the random access channel procedure.

15. The method of claim 13, wherein the transmit power associated with transmission of the physical uplink shared channel message is based at least in part on a closed loop power control parameter,
wherein a value of the closed loop power control parameter is based at least in part on a multiplication of a power ramping increment parameter associated with the slot type of the additional slot by the quantity of preambles of the one or more preambles, and
wherein the quantity of preambles corresponds to a quantity of preambles transmitted by the wireless device for the random access channel procedure via a subset of slots of the one or more slots that are associated with a same slot type as the slot type of the additional slot.

16. The method of claim 13, wherein the transmit power associated with transmission of the physical uplink shared channel message is based at least in part on a closed loop power control parameter,
wherein a value of the closed loop power control parameter is based at least in part on a multiplication of a power ramping increment parameter associated with the slot type of the additional slot by a first quantity of a first subset of the quantity of preambles and a multiplication of a power ramping increment parameter associated with a slot type different from the slot type of the additional slot by a second quantity of a second subset of the quantity of preambles,
wherein the first subset of the quantity of preambles corresponds to a quantity of preambles transmitted by the wireless device for the random access channel procedure via a first set of slots of the one or more slots that are associated with a same slot type as the slot type of the additional slot, and
wherein the second subset of the quantity of preambles corresponds to a quantity of preambles transmitted by the wireless device for the random access channel procedure via a second set of slots of the one or more slots that are associated with the slot type that is different than the slot type of the additional slot.

17. The method of claim 13, wherein a closed loop power control parameter is based at least in part on a closed loop power adjustment parameter associated with the slot type of the additional slot, and
wherein the transmit power is based at least in part on the closed loop power control parameter.

18. The method of claim 17, wherein the closed loop power adjustment parameter is multiplied by the quantity of preambles of the one or more preambles, and
wherein the quantity of preambles corresponds to a quantity of preambles transmitted by the wireless device for the random access channel procedure via a subset of slots of the one or more slots that are associated with a slot type that is different from the slot type of the additional slot.

19. The method of claim 13, wherein the transmit power associated with transmission of the physical uplink shared channel message is based at least in part on a closed loop power control parameter, and
wherein a value of the closed loop power control parameter is based at least in part on a power ramping parameter that is set to zero upon transmission of a first preamble of the one or more preambles in a first slot of the one or more slots associated with a first slot type and transmission of a subsequent preamble of the one or more preambles in a second slot of the one or more slots associated with a second slot type different from the first slot type.

20. A non-transitory computer-readable medium storing code for wireless communications, the code comprising instructions executable by one or more processors to:
transmit one or more preambles of a random access channel procedure via a corresponding one or more slots;
transmit a physical uplink shared channel message of the random access channel procedure in an additional slot using a transmit power based at least in part on a quantity of preambles of the one or more preambles and on a slot type of the additional slot, the slot type comprising a half-duplex slot or a subband full-duplex slot; and
monitor for a message responsive to the one or more preambles, the physical uplink shared channel message, or both.
